(19) United States
(12) Patent Application Publication
(10) Pub. No.: US 2020/0197887 A1
(43) Pub. Date: Jun. 25, 2020

(54) FERROMAGNETIC ROTORS FOR AGITATING THE LIQUID IN A MICROWELL

(71) Applicant: Access Medical Systems, Ltd., Palo Alto, CA (US)

(72) Inventors: Hong TAN, San Jose, CA (US); Haode CHEN, Shanghai (CN); Genqian LI, Shanghai (CN)

(21) Appl. No.: 16/810,545

(22) Filed: Mar. 5, 2020

Related U.S. Application Data
(63) Continuation of application No. PCT/US2018/049591, filed on Sep. 5, 2018.
(60) Provisional application No. 62/554,962, filed on Sep. 6, 2017.

(51) Int. Cl. B01F 13/08; B01F 15/00

(52) U.S. Cl. CPC B01F 13/0818; B01F 15/00389; B01L 3/5085; B01F 2215/0037; B01F 2215/0431

(57) ABSTRACT

Introduced here are rotors that can be placed inside of microplate wells that include liquid samples. Each rotor can be comprised of a ferromagnetic material. Accordingly, when a rotor is subjected to an external rotational magnetic field, the rotor spins and agitates the liquid sample inside the corresponding well. The spin speed may be adjusted by changing the rotation speed, direction, and/or orientation of the external rotational magnetic field. The rotor typically includes a central cavity within which a probe can be suspended during the biochemical test.

### CROSS-REFERENCE TO RELATED APPLICATIONS

This application is a continuation of International Application No. PCT/US2018/049591, filed on Sep. 5, 2018, which claims priority to U.S. Provisional Application No. 62/554,962, filed on Sep. 6, 2017. The contents of the above-identified applications are incorporated by reference in their entirety.

### FIELD OF THE INVENTION

Various embodiments pertain to equipment for biochemical testing and, more specifically, ferromagnetic rotors able to agitate the liquid sample in a microwell, such as a microplate well or a test cartridge well.

### BACKGROUND

In the development of biochemical testing systems (e.g., immunoassay systems), many performance requirements need to be met. Assays need to be sensitive enough to detect an analyte at very low levels in the sub-picogram to nanogram per milliliter range. Moreover, total assay time often needs to be 15 minutes or less in order to provide timely results for patients in point-of-care situations, or to meet throughput requirements for batch analyzers.

Analyte panels able to simultaneously perform multiple assays with a single sample are advantageous because they minimize the turnaround time for results and the costs of testing. Microplates that have multiple wells for holding separate liquid samples are also advantageous because they enable multiple liquid samples to be tested simultaneously or sequentially in quick succession. However, there exists a need for biochemical testing equipment able to more effectively and efficiently agitate the liquid samples within the wells of a microplate.

### BRIEF DESCRIPTION OF THE DRAWINGS

Various objects, features, and characteristics of the technology will become apparent to those skilled in the art from a study of the Detailed Description in conjunction with the drawings.

FIG. 1 depicts a cylindrical rotor that can be placed inside of a well that includes a liquid sample.

FIG. 2 illustrates how a cylindrical rotor can be subjected to an external rotational magnetic field when placed within a well that includes a liquid sample.

FIG. 3 shows how, upon subjecting a cylindrical rotor to an external rotational magnetic field, the cylindrical rotor spins and agitates the liquid sample inside the well.

FIG. 4 depicts several different examples of rotors.

FIG. 5 depicts several different plates having microwells (also referred to more simply as “wells”).

FIG. 6 includes a flow diagram of a process for causing a liquid sample in a well to be agitated by a cylindrical rotor.

The drawings depict various embodiments described throughout the Detailed Description for the purpose of illustration only. While specific embodiments have been shown by way of example, the technology is amenable to various modifications and alternative forms. The intention is not to limit the technology to the particular embodiments illustrated and/or described.

### DETAILED DESCRIPTION

Introduced here are rotors that can be placed inside of a microwell that includes a liquid sample (e.g., a biological sample). “Microwells,” as used herein, refer to wells having a small inner diameter, for example, no more than 50 mm, preferably no more than 30 mm, no more than 20 mm, or no more than 10 mm. In one embodiment, microwells have a size of 2-50 mm, 2-20 mm, or 2-10 mm. The microwell may be one of multiple wells included on a microplate. The rotor can be subjected to an external rotational magnetic field, which causes the rotor to spin. Such action will agitate the liquid sample inside the well. Thus, a microwell that includes a rotor may be referred to as a “whirlpool well.”

Whirlpool wells can be used for conducting biochemical tests, such as enzyme-linked immunosorbent assays (ELISAs) and probe-based tests (e.g., those offered by ForteBio Octet and ET Healthcare Pylon). A “probe”, as used herein, refers to a substrate coated with a thin-film layer of analyte-binding molecules at the sensing side. Additionally or alternatively, whirlpool wells can be used for reconstituting and/or mixing of reagents before, during, or after the testing process.

Rotors designed for installation within a well will be often in the form of annular cylinders having an open central cavity. Thus, the rotor can be designed to include a central cavity within which a probe can be suspended during a biochemical test. Moreover, the rotor may be designed so that the rotor can spin within the well without excessive horizontal movement. Excessive horizontal movement may cause the rotor to come into contact with the probe, which could damage the testing equipment and/or affect the reliability of the test results. While embodiments may be described in the context of cylindrical rotors, those skilled in the art will recognize that the rotors need not necessarily be cylindrical.

Rotor spin characteristics can be modified by changing the rotation speed, direction, and/or orientation of the external rotational magnetic field. For example, the speed at which a rotor spins may be adjusted by changing the rotation speed of the external rotational magnetic field.

Such a design provides several advantages over the magnetic beads and magnetic bars that have conventionally been used in combination with microwells. For example, the rotors described herein can create sufficient agitation to more effectively prevent undesirable rebinding of components and disturb the mass transport layer that often forms along the top of liquid samples. Increased turbulence can also improve dissociation of components, improve the binding reaction, etc.

Moreover, because the rotors are normally comprised of a ferromagnetic material, the rotors can be controlled using an external magnetic field. Since no invasive mechanisms are needed to cause movement of the rotors, a cover can be placed over the corresponding well. While the cover may include a single aperture through which a probe can be extended, the cover can prevent the evaporation of liquid samples (which plagues some sensitive biochemical tests).

Further yet, several rotors introduced here include a substantially cylindrical body having a central cavity with an open top end and/or an open bottom end. These ferromagnetic rotors permit greater flexibility in biochemical testing. For example, such a design allows testing equipment to generate readings based on imaging light emitted through the bottom of the well (e.g., by a laser). Such measurements cannot be made when magnetic bead(s) or magnetic bar(s) sit upon the bottom of the well, thereby causing reflection of the imaging light.

### Terminology

Brief definitions of terms, abbreviations, and phrases used throughout the application are given below.

The terms “connected,” “coupled,” or any variant thereof means any connection/coupling, either direct or indirect, between two or more elements. The coupling or connection between the elements can be physical and/or logical. For example, two components could be coupled directly to one another or via intermediary channel(s) or component(s).

### System Topology Overview

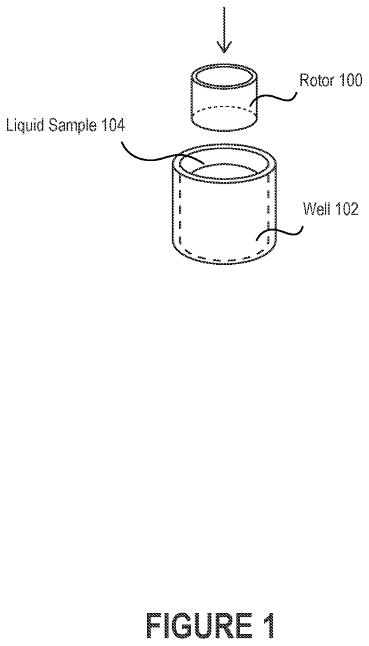

FIG. 1 depicts a cylindrical rotor 100 that can be placed inside of a well 102 that includes a liquid sample 104. The liquid sample 104 may be, for example, a biological sample having an analyte. The cylindrical rotor 100 can be comprised of a ferromagnetic material, such as cobalt, iron, a ferromagnetic alloy, a plastic ferromagnetic composite material, etc. The cylindrical rotor 100 may be comprised of a combination of such materials. In some embodiments, the cylindrical rotor 100 also includes one or more non-ferromagnetic materials (e.g., plastic, glass, or rubber). For example, the cylindrical rotor 100 may include a coating (e.g., comprised of silicon rubber) that inhibits exposure of the ferromagnetic material(s) to the liquid sample 104.

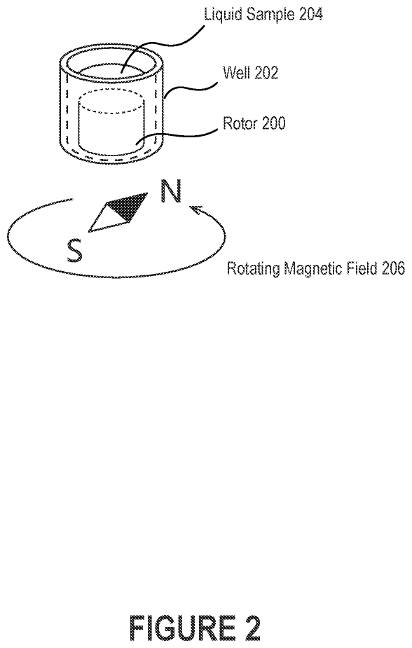

FIG. 2 illustrates how a cylindrical rotor 200 can be subjected to an external rotational magnetic field 206 when placed within a well 202 that includes a liquid sample 204. The external rotational magnetic field 206 causes the cylindrical rotor 200 to spin, which agitates the liquid sample 204 inside the well 202. Such action may occur during a biochemical test, such as enzyme-linked immunosorbent assays (ELISAs) and probe-based tests (e.g., those offered by ForteBio Octet and ET Healthcare Pylon). For example, the cylindrical rotor 200 may be used to facilitate the reconstituting and/or mixing of reagents before, during, or after the testing process.

Rotor spin characteristics can be modified by changing the rotation speed, direction, and/or orientation of the external rotational magnetic field 206. For example, the speed at which the rotor 200 spins may be adjusted by changing the rotation speed of the external rotational magnetic field 206.

The external rotational magnetic field 206 can be created by a magnetized material and/or moving electric charges (i.e., electric currents). Rotating magnetic fields are a key principle in a variety of conventional technologies, including alternating-current motors. To produce the external rotational magnetic field 206, a permanent magnet (not shown) may be rotated so as to maintain its alignment with the external rotational magnetic field 206.

The external rotational magnetic field 206 may be produced by a three-phase system where the three currents are roughly equal in magnitude and have 120 degrees phase different. In such embodiments, three similar coils having mutual geometrical angles of 120 degrees can create the external rotational magnetic field 206. As shown in FIG. 2, by placing these coils underneath the well 202, the cylindrical rotor 200 may be driven in a particular direction (i.e., either clockwise or counter-clockwise). Those skilled in the art will recognize that a variety of different technologies may be used to produce a rotating magnetic field whose operating characteristics can be controllably varied.

A rotating or alternating magnetic field can be created proximate to the well 202 (and thus the cylindrical rotor 200) by rotating one or more permanent magnets. For example, the permanent magnet(s) may be located beneath the well 202 to avoid interfering with a biochemical test that requires a probe be inserted through the opening of the well 202. Alternatively, a rotating or alternating magnetic field can be created through the use of electric coils similar to an electric motor.

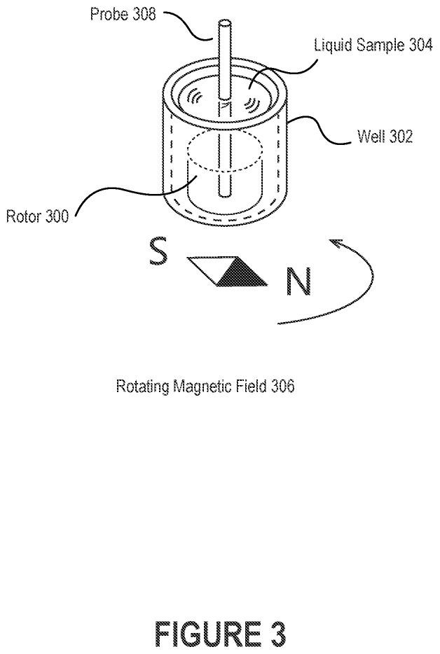

FIG. 3 shows how, upon subjecting a cylindrical rotor 300 to an external rotational magnetic field 306, the cylindrical rotor 300 spins and agitates the liquid sample 304 inside the well 302. As further described below, the rotor 300 need not necessarily be cylindrical. However, the rotor 300 is typically designed so that it includes a central cavity.

During a biochemical test, a probe 308 can be suspended within the central cavity. Examples of probe-based detection technologies are described in U.S. Pat. No. 8,309,369, titled “Detection System and Method for High Sensitivity Fluorescent Assays,” and U.S. Pat. No. 8,753,574, titled “Systems for Immunoassay Tests,” each of which is incorporated by reference herein in its entirety. Such a design ensures that the probe 308 does not lose its binding affinity and is not harmed by the cylindrical rotor 300 as the cylindrical rotor 300 spins within the well 302.

The cylindrical rotor 300 may be partially or fully immersed in a liquid sample 304 when placed within a well 302. Thus, in some embodiments the cylindrical rotor 300 will be partially exposed above a surface of the liquid sample 304, while in other embodiments the cylindrical rotor 300 will be fully submerged beneath the surface of the liquid sample 304. The cylindrical rotor 300 may have a height of no more than 200 millimeters (mm), preferably no more than 100 mm, no more than 75 mm, no more than 50 mm, or no more than 25 mm. In one embodiments, the cylindrical rotor 300 has a height of 5-200 mm, 5-100 mm, 5-75 mm, 5-50 mm, 5-25 mm, or 5-10 mm. In some embodiments, the height of the cylindrical rotor 300 is based on the depth of the well 302. For example, the depth of the well 302 may be at least 10% larger, or at least 25% larger, or at least 50% larger than the height of the cylindrical rotor 300. Thus, the height of the cylindrical rotor may be 5-9.1 mm for a 10 mm deep microwell, 7.5-13.6 mm for a 15 mm deep microwell, 10-18.2 mm for a 20 mm deep microwell, etc.

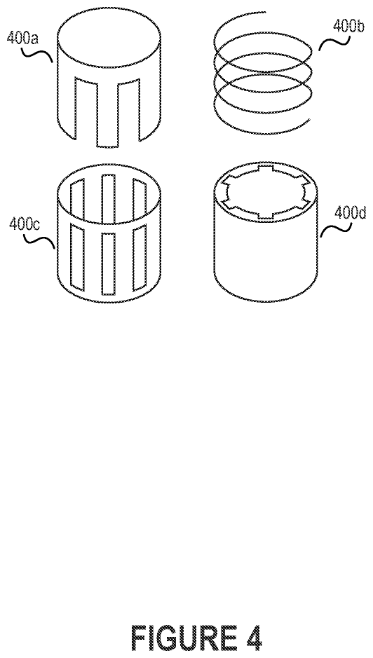

Embodiments have been described in the context of cylindrical rotors for the purpose of illustration only. Those skilled in the art will recognize that a rotor could be other shapes as well. FIG. 4 depicts several different examples of rotors 400a-d. Generally, the rotor can be made in different shapes so long as the rotor does not come into contact with the probe (or any other testing equipment) as the rotor spins within the well.

Here, for example, several different designs having central cavities are shown. A first rotor 400a includes a cylindrical structural body having a series of teeth that extend downward toward an open bottom end. A second rotor 400b includes a cylindrical structural body formed from a material that is molded into a shape roughly similar to a spring. A third rotor 400c includes a cylindrical structural body having a series of apertures in the sidewall that expose the central cavity. A fourth rotor 400d includes a cylindrical structural body having a solid sidewall. While the first, second, and third rotors 400a-c have elliptical (e.g., circular) inner diameters, the fourth rotor 400 includes a non-elliptical inner diameter. Here, for example, the inner diameter of the fourth rotor 400 is a gear-like shape.

These rotor 400a-d may create different levels of agitation. For example, the second rotor 400b (also referred to as the “spring-shaped rotor” or “spiral-shaped rotor”) may create the most agitation. In some embodiments, the structural body of the rotor includes one or more flow interfaces. The flow interface(s) extend from an outer wall to an inner wall defining the central cavity. The flow interface(s) enable liquid to flow into and out of the central cavity. In some embodiments, the boundaries of the flow interface(s) are completely defined, as can be seen with respect to rotor 400c. In other embodiments, the boundaries of the flow interface(s) are partially defined, as can be seen with respect to rotor 400a.

A rotor can include a substantially cylindrical body that is comprised of a ferromagnetic material. The substantially cylindrical body can include an outer wall and an inner wall disposed circumferentially around a central cavity. The substantially cylindrical body also includes an open top end through which probes can extend. In some embodiments the substantially cylindrical body includes an open bottom end, while in other embodiments the substantially cylindrical body includes a closed bottom end.

The outer wall of the rotor will typically have a diameter slightly smaller than the inner diameter of the well. Such a design ensures that the rotor can spin within the well without excessive horizontal movement. Excessive horizontal movement may cause the rotor to come into contact with the probe, which could damage the testing equipment and/or affect the reliability of the test results.

In some embodiments, the central cavity is defined by a tapered inner wall that narrows toward either the top end or the bottom end. Thus, the central cavity may decrease in width along the length of the rotor to guide flow in a particular manner (e.g., upward toward the surface of the liquid sample or downward toward the bottom of the well).

Generally, the rotor does not extend above the liquid sample in the well because such exposure will create additional friction. Thus, enough liquid will generally be deposited into the well to entirely cover the rotor. The height of the rotor is often less than the depth of the liquid sample in the well. In some embodiments, the height of the rotor is designed to be substantially similar to the depth of the liquid sample. In such embodiments, agitation occurs throughout the liquid column.

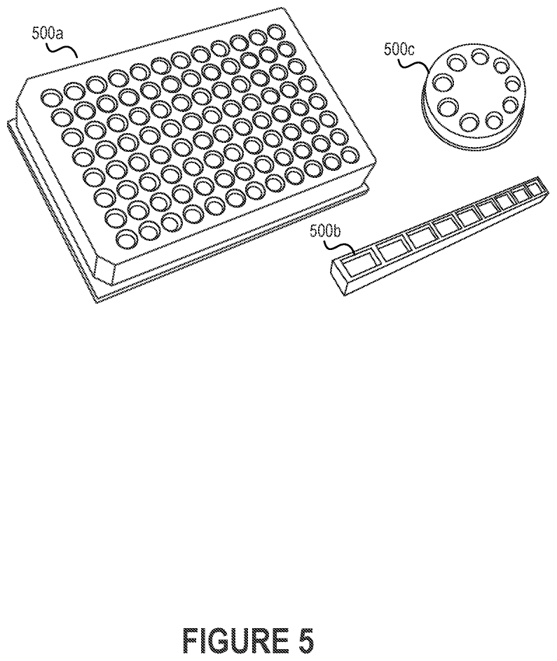

FIG. 5 depicts several different plates having microwells (also referred to more simply as “wells”). More specifically, FIG. 5 depicts a first plate 500a in a standard 96-well format, a second plate 500b having a linear array of wells, and a third plate 500c having a circular array of wells. In some embodiments each well on a plate includes a rotor, while in other embodiments only a subset of the wells include a rotor.

The diameter of a rotor is typically at least 5% smaller, or at least 10% smaller, or at least 25% smaller than the inner diameter of the well in which the rotor is to be placed. The diameter of the rotor may be 1-45 mm. For example, the diameter of the rotor may be 7.5-9.5 mm for a 10 mm diameter microwell, 10-13.3 mm for a 14 mm diameter microwell, 15-19 mm for a 20 mm microwell, etc. The diameter of a well (also referred to more generally as the “shape” of the well) can be round, square, polygon, etc. Moreover, different well shapes can be mixed in a group or an array. For example, the 96-well format microplate shown here may include rows of round wells and rows of square wells. The shape and size of a well may affect the design of the rotor to be placed within the well. For example, to account for the differences in how liquid flows within round and square wells, an individual may need to install rotors of a first shape in round wells and rotors of a second shape in square wells.

While embodiments may be described in the context of microplates, rotor(s) may also be installed within the well(s) of a test cartridge. A test cartridge can include a plurality of wet wells, a measurement well that includes a light-transmissive bottom, a probe well, a protective cap designed to enclose an upper end of a probe that extends above the probe well. Examples of test cartridges are described in U.S. Pat. No. 8,753,574, titled “Systems for Immunoassay Tests,” and U.S. Pat. No. 9,616,427, titled “Cartridge Assembly Tray for Immunoassay Tests,” each of which is incorporated by reference herein in its entirety.

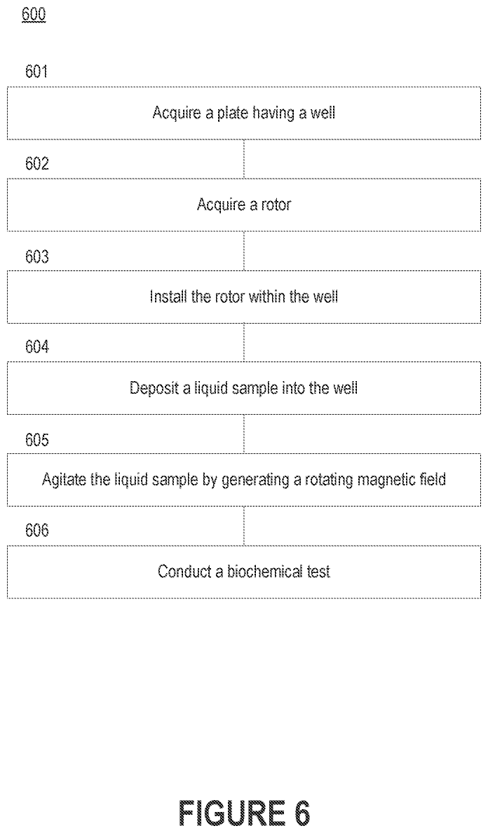

FIG. 6 includes a flow diagram of a process 600 for causing a liquid sample in a well to be agitated by a cylindrical rotor. Initially, an individual acquires a plate having a well (step 601). The individual may be, for example, a person involved in biochemical testing. The individual also acquires a rotor to be installed within the well (step 602). The rotor can include a substantially cylindrical body having a central cavity with an open top end and/or an open bottom end. Moreover, the rotor can be comprised of a ferromagnetic material.

The individual can then install the rotor within the well (step 603). For example, the individual may place the rotor within the well using her hands or another instrument (e.g., an antimicrobial tweezers). Thereafter, the individual can deposit a liquid sample into the well (step 604). In some embodiments the liquid sample is manually injected into the well, while in other embodiments the liquid sample is automatically injected into the well (e.g., by an automatic injection machine).

After depositing the liquid sample into the well, the individual can cause the liquid sample to be agitated by generating a rotating magnetic field (step 605). For example, the individual may interact with a mechanism (e.g., a mechanical button of a probe-based detection system or an interface element shown on a display of the probe-based detection system) to initiate the generation of the rotating magnetic field. Thus, the individual may be able to manually control whether the rotor is rotating, as well as characteristics of the movement (e.g., rotation speed). In other embodiments, the probe-based detection system automatically controls whether the rotor is rotating. For example, the probe-based detection system may be configured to automatically modify the rotating magnetic field based on a detected characteristic (e.g., clarity of the liquid sample).

The individual can then conduct a biochemical test (step 606). In some embodiments the biochemical test is conducted while the liquid sample is being agitated, while in other embodiments the biochemical test is conducted after the liquid sample has been agitated.

Unless contrary to physical possibility, it is envisioned that the steps described above may be performed in various sequences and combinations. For example, the liquid sample may be deposited into the well before the rotor is installed within the well. As another example, the liquid sample may be agitated on a periodic basis due to periodic generation of the rotating magnetic field.

Moreover, multiple instances of the same step may be performed simultaneously or successively. For instance, if the plate is in a standard 96-well format, liquid samples could be deposited into any number of the 96 wells. Similarly, rotors could be installed within any number of the 96 wells. For example, cylindrical rotors may only be installed within a subset of the wells that include liquid samples.

### Remarks

The foregoing description of various embodiments of the technology has been provided for the purposes of illustration and description. It is not intended to be exhaustive or to limit the claimed subject matter to the precise forms disclosed.

Many modifications and variation will be apparent to those skilled in the art. Embodiments were chosen and described in order to best describe the principles of the technology and its practical applications, thereby enabling others skilled in the relevant art to understand the claimed subject matter, the various embodiments, and the various modifications that are suited to the particular uses contemplated.

What is claimed is:

1. A rotor for agitating a liquid sample in a microwell, the rotor comprising:
a substantially cylindrical structural body having
an open top end,
an outer wall, and
an inner wall disposed circumferentially around a central cavity,
wherein the substantially cylindrical structural body is comprised of a ferromagnetic material, and
wherein when the rotor is placed in the microwell, the substantially cylindrical structural body rotates when subjected to a rotating magnetic field, said rotating causing agitation of the liquid sample in the microwell.

2. The rotor of claim 1, wherein the substantially cylindrical structural body is in a spiral form.

3. The rotor of claim 1, wherein the open top end enables a probe to be suspended into the central cavity during a biochemical test.

4. The rotor of claim 1, wherein agitation of the liquid sample is variable during a biochemical test by changing a rotation speed of the rotating magnetic field.

5. The rotor of claim 1, wherein the ferromagnetic material is cobalt, iron, a ferromagnetic alloy, a plastic ferromagnetic composite material, or any combination thereof.

6. The rotor of claim 1, wherein the substantially cylindrical structural body includes one or more flow interfaces extending from the outer wall to the inner wall, the one or more flow interfaces enabling the liquid sample to flow into the central cavity.

7. The rotor of claim 1, wherein the substantially cylindrical structural body further includes an open bottom end through which imaging light is shown during a biochemical test.

8. A method of agitating a liquid sample in a microwell using the rotor of claim 1, the method comprising:
placing the rotor in the microwell; and
applying a rotating magnetic field to rotate the rotor, thereby agitating the liquid sample in the microwell.

9. The method of claim 8, wherein the rotor is comprised of a ferromagnetic material and at least one other material.

10. The method of claim 8, further comprising:
during a biochemical test,
varying rotational speed, direction, or orientation of the rotating magnetic field to vary the extent of agitation of the liquid sample.

11. A rotor for agitating a liquid sample in a microwell, the rotor comprising:
an open cylindrical body having a central cavity defined therethrough,
wherein the open cylindrical body is comprised of a ferromagnetic material, and
wherein the open cylindrical body rotates when subjected to a rotating magnetic field, said rotating causing agitation of the liquid sample in the microwell.

12. The rotor of claim 11, wherein the open cylindrical body includes one or more sidewall apertures through which the liquid sample can flow.

13. The rotor of claim 11, wherein a diameter of the open cylindrical body is 15-19 millimeters, or 10-13.3 millimeters, or 5-9.1 millimeters.

14. The rotor of claim 11, wherein a height of the open cylindrical body is 7.5-13.6 millimeters or 10-18.2 millimeters.

15. The rotor of claim 11, further comprising:
a coating that inhibits exposure of the ferromagnetic material to the liquid sample.

16. The rotor of claim 15, wherein the coating is comprised of silicon rubber.
